(19) United States
(12) Patent Application Publication
(10) Pub. No.: US 2026/0279877 A1
(43) Pub. Date: Sep. 17, 2026

(54) BATTERY CELL CLASSIFICATION CONTROL APPARATUS AND METHOD OF CONTROLLING THE SAME

(71) Applicant: Samsung SDI Co., Ltd., Yongin-si (KR)

(72) Inventors: Ji Soo KIM, Suwon-si (KR); Hyung Chun LEE, Suwon-si (KR)

(21) Appl. No.: 19/562,717

(22) Filed: Mar. 10, 2026

(30) Foreign Application Priority Data
Mar. 11, 2025 (KR) 10-2025-0031432

(51) Int. Cl. H01M 10/04; G01B 21/08

(52) U.S. Cl. CPC H01M 10/0404; G01B 21/08

(57) ABSTRACT

A battery cell classification control apparatus includes a communication circuit configured to receive thickness data from a measurement device that is configured to measure a thickness of a battery cell; and a processor configured to calculate a predicted thickness by predicting a final thickness of the battery cell to be packaged based on the thickness data, to set a grade of each battery cell based on the predicted thickness, and when the battery cell is packaged, to control the battery cell to be classified according to the grade.

### CROSS-REFERENCE TO RELATED APPLICATION

The present application claims priority to and the benefit of Korean Patent Application No. 10-2025-0031432, filed on Mar. 11, 2025, in the Korean Intellectual Property Office, the entire disclosure of which is incorporated herein by reference.

### BACKGROUND

### 1. Field

Aspects of the present disclosure relate to a battery cell classification control apparatus for classifying a battery cell according to a thickness thereof and a method of controlling the same.

### 2. Description of the Related Art

During the manufacturing process of a secondary battery, battery cells are stacked and packaged according to an order of manufacture of the battery cells. Because the battery cells packaged as described above are sequentially loaded and moved, the battery cells are assembled into a battery module or battery pack according to the order of manufacture thereof.

The thickness of the battery cell is affected by an electrode plate or assembly processes, and a difference in thickness between the battery cells occurs according to the electrode plate or assembly process. Because battery cells produced using the same reel are sequentially input due to characteristics of a battery process, the battery cells tend to have the same thickness based on the reel.

Accordingly, because the battery cells are assembled in the order of loading thereof during the assembly process of the battery module or battery pack, a phenomenon in which the battery cells having the same thickness are concentrated in a specific module or pack occurs.

The thicknesses of battery cells are not distributed randomly, and thick battery cells may be sequentially input to a battery module or battery pack, or thin battery cells may be sequentially input to a battery module or battery pack.

A difference in final thickness between completely assembled battery modules or battery packs occurs, and such a difference affects a compression force.

While the compression force needs to be managed as an important factor in the battery module or battery pack, there is a problem that there is no method of controlling the compression force during the assembly process of the battery module or battery pack.

The above information disclosed in this Background section is for enhancement of understanding of the background of the present disclosure, and therefore, it may contain information that does not constitute related (or prior) art.

### SUMMARY

Aspects of embodiments of the present disclosure are directed to a battery cell classification control apparatus for classifying a battery cell according to a thickness thereof to adjust a compression force of a module or battery pack, and a method of controlling the same.

However, objects that the present disclosure intends to achieve are not limited to the above-described objects and other objects that are not described may be clearly understood by those skilled in the art from the following description.

According to some embodiments of the present disclosure, there is provided a battery cell classification control apparatus including: a communication circuit configured to receive thickness data from a measurement device that is configured to measure a thickness of a battery cell; and a processor configured to calculate a predicted thickness by predicting a final thickness of the battery cell to be packaged based on the thickness data, to set a grade of each battery cell based on the predicted thickness, and when the battery cell is packaged, to control the battery cell to be classified according to the grade.

In some embodiments, the processor is configured to calculate the predicted thickness based on the thickness data measured during a stack process in which a separator, a negative electrode sheet, and a positive electrode sheet are stacked.

In some embodiments, the processor is configured to calculate the predicted thickness by predicting a thickness of a cell package that is primarily packaged based on the thickness data, and to predict a thickness of a final cell package that is finally packaged based on a predicted value.

In some embodiments, the processor is configured to calculate a correlation equation by analyzing the thickness of the battery cell during a stack process, a thickness of a cell package that is primarily packaged, and a thickness of a final cell package that is finally packaged, and to calculate the predicted thickness according to the correlation equation.

In some embodiments, the processor is configured to perform a simulation for assembling a battery module or a battery pack by combining a plurality of battery cells having different thicknesses, and to set the plurality of battery cells as battery cell groups according to a result of the simulation.

In some embodiments, the processor is configured to perform the simulation for a uniform thickness of the battery module or the battery pack by combining the plurality of battery cells having different thicknesses.

In some embodiments, the processor is configured to enable the battery cell to be assembled according to group data associated with the battery cell groups during an assembly process of the battery module or the battery pack.

In some embodiments, the processor is configured to set a battery cell predicted to be defective as a defective cell during performing of the simulation, and to control the defective cell to be separated before packaging is performed.

In some embodiments, the processor is configured to determine a battery cell having a predicted thickness outside a set range as a defective cell, and to control the defective cell to be separated before packaging is performed.

According to some embodiments of the present disclosure, there is provided a battery cell classification control system including: a battery manufacturing apparatus is configured to perform a stack process, a cell package process, a final cell package process, a classification process, and a module pack assembly process; and a classification control apparatus is configured to predict a thickness of a battery cell, on which the final cell package process is completely performed, based on a thickness of the battery cell measured during the stack process, to set a grade of the battery cell according to the predicted thickness, and to control the battery cell to be classified according to the grade during the classification process.

In some embodiments, the classification control apparatus is configured to calculate the predicted thickness by predicting the thickness of the battery cell, on which the cell package process is completely performed, based on the thickness of the battery cell measured during the stack process and predicting the thickness of the battery cell, on which the final cell package process is completely performed, based on a predicted value.

In some embodiments, the classification control apparatus is configured to separate the battery cell as a defective cell based on the thickness the battery cell being outside a set range.

In some embodiments, the classification control apparatus is configured to set battery cell groups by combining a plurality of battery cells having different thicknesses based on the predicted thickness and to control the battery cell to be assembled according to group data associated with the battery cell groups during an assembly process of a battery module or a battery pack.

According to some embodiments of the present disclosure, there is provided a method of controlling battery cell classification, including: receiving, by a processor, thickness data from a measurement device configured to measure a thickness of a battery cell through a communication circuit; calculating, by the processor, a predicted thickness by predicting a final thickness of the battery cell, which is packaged, based on the thickness data; setting, by the processor, a grade of the battery cell based on the predicted thickness; and controlling, by the processor, the battery cell to be classified according to the grade when the battery cell is finally packaged.

In some embodiments, the calculating of the predicted thickness includes: predicting, by the processor, a thickness of a cell package, which is primarily packaged, based on of the thickness data; and calculating, by the processor, the predicted thickness by predicting a thickness of a final cell package, which is finally packaged, based on a predicted value.

In some embodiments, the method further includes, after the calculating of the predicted thickness, performing, by the processor, a simulation for assembling a battery module or a battery pack by combining a plurality of battery cells having different thicknesses based on the predicted thickness.

In some embodiments, in the performing of the simulation, the processor performs the simulation for uniformizing a thickness of the battery module or the battery pack by combining the plurality of battery cells having different thicknesses. In some embodiments, the method further includes, after the performing of

the simulation: setting, by the processor, a battery cell predicted to be defective during performing of the simulation as a defective cell; setting, by the processor, a battery cell having a predicted thickness outside a set range as a defective cell; and controlling, by the processor, the defective cell to be separated before packaging is performed.

In some embodiments, in the receiving of the thickness data, the processor is configured to calculate the predicted thickness of the battery cell, which is finally packaged, based on the thickness data measured during a stack process in which a separator, a negative electrode sheet, and a positive electrode sheet are stacked.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a view illustrating a configuration of a battery cell classification control system according to some embodiments of the present disclosure;

FIG. 2 is a block diagram illustrating a control configuration of a classification control apparatus according to some embodiments of the present disclosure;

FIG. 3 is a reference view for describing a compression force of a battery module according to some embodiments of the present disclosure;

FIG. 4 is a view illustrating grades of thicknesses of battery cells according to some embodiments of the present disclosure;

FIGS. 5A, 5B, and 5C are graphs showing predicted thicknesses of battery cells according to some embodiments of the present disclosure;

FIG. 6 is an exemplary table showing thicknesses and predicted values of battery cells for each manufacturing step according to some embodiments of the present disclosure;

FIGS. 7A, 7B, and 7C are exemplary graphs showing predicted thicknesses of battery cells for each manufacturing step according to some embodiments of the present disclosure; and

FIG. 8 is a flowchart illustrating a method of controlling battery cell classification according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform to within a given region or range, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

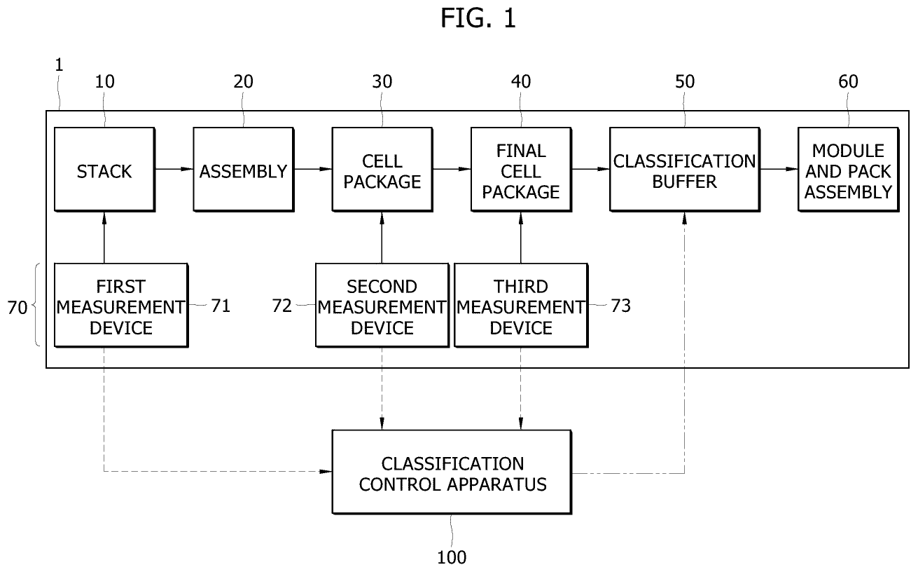

FIG. 1 is a view illustrating the configuration of a battery cell classification control system according to some embodiments of the present disclosure.

Referring to FIG. 1, the battery cell classification control system according to some embodiments of the present disclosure may include a classification control apparatus 100 and a battery manufacturing apparatus 1.

The classification control apparatus 100 calculates predicted thicknesses on the basis of thicknesses of the battery cells measured during a battery cell manufacturing process of the battery manufacturing apparatus 1, classifies battery cells, and controls battery modules and battery packs to be assembled on the basis of the classified battery cells.

The battery manufacturing apparatus 1 may perform a stack process 10, an assembly process 20, a cell package process 30, a final cell package process 40, a classification process 50, and a module and pack assembly process 60. In such examples, an example in which the classification process 50 and the module and pack assembly process 60 are performed in one manufacturing apparatus will be described, but the classification process 50 and the module and pack assembly process 60 may be performed using separate apparatuses as desired.

The stack process 10 is a step of sequentially loading a separator, a negative electrode sheet, and a positive electrode sheet to manufacture a battery cell and may generate a jelly roll by stacking the sheets and the separator in the sequence of separator-negative electrode sheet-separator-positive electrode sheet. In such examples, the jelly roll is an electrode assembly in which the positive electrode sheet or the negative electrode sheet and the separator are bonded and wound in a roll type in order to form a cell which is a basic unit of a battery.

The assembly process 20 is a step of assembling components with a stack, the cell package process 30 is a step of packaging battery cells, and the final cell package process 40 is a step of completing the packaging of the battery cells and finally inspecting the battery cells. In such examples, a cell package is in a state in which each of the battery cells is primarily packaged through a stack assembly. A final cell package is in a state in which the cell package is finally inspected and finally packaged. For example, the battery cell may be packaged into a prismatic battery cell.

In such examples, the battery manufacturing apparatus 1 may include a plurality of measurement devices 71, 72, and 73 and measure thicknesses of the battery cells for each process. The first measurement device 71 is installed for the stack process 10 and measures a stack thickness of a battery cell. The second measurement device 72 is installed for the cell package process 30 and measures a thickness of a packaged battery cell, that is, a thickness of a cell package. The third measurement device 73 is installed for the final cell package process 40 and measures a thickness of a final cell package.

The classification control apparatus 100 may receive measured thickness data from the plurality of measurement devices 71, 72, and 73 for each step. The classification control apparatus 100 may predict final thicknesses on the basis of the thickness data received from the measurement device 70 and may set grades to classify battery cells according to thicknesses thereof.

The classification control apparatus 100 may predict thicknesses of final cell packages on the basis of stack thicknesses measured during the stack process 10 and classify battery cells on the basis of the thicknesses predicted at a time when the final cell package process 40 is completed. In such examples, the classification control apparatus 100 may predict thicknesses of the cell packages on the basis of the stack thicknesses and predict the thicknesses of the final cell packages on the basis of the predicted thicknesses of the cell packages.

In addition, the classification control apparatus 100 may perform a simulation to correspond to the thicknesses of the final cell packages predicted on the basis of the stack thicknesses, that is, the predicted final cell package thicknesses and detect a defective cell according to a result of the simulation. The classification control apparatus 100 may determine a possibility of defect occurrence through the simulation and may separately classify a battery cell predicted to be defective.

The classification control apparatus 100 inputs grades of the battery cells set on the basis of the predicted thicknesses of the final cell packages to the battery manufacturing apparatus 1. When the grades of the battery cells are set according to the thicknesses, the battery manufacturing apparatus 1 may classify the battery cells on the basis of the grades.

Accordingly, the battery manufacturing apparatus 1 may classify the battery cells according to the grades of the final cell packages and load the classified battery cells on a plurality of classification buffers. The battery cells loaded on the classification buffers as described above may be moved to the module and pack assembly process 60 and combined and assembled according to the thicknesses.

The battery manufacturing apparatus 1 transmits the battery cells classified according to the grades to the module and pack assembly process 60, forms groups according to the thicknesses of the battery cells, and assembles battery modules or battery packs during the assembly process 60.

The classification control apparatus 100 may set battery cell groups, which will be included in modules or packs, on the basis of the thicknesses of battery cells and input the battery cell groups to the assembly process 60. The classification control apparatus 100 may set a battery cell group such that thick battery cells and thin battery cells are included one group. The classification control apparatus 100 may set (e.g., determine) battery cell groups such that constant thicknesses of battery modules or battery packs are maintained.

Accordingly, the battery manufacturing apparatus 1 may assemble battery modules or battery packs by combining battery cells having various thicknesses on the basis of battery cell groups. Hereinafter, the assembly process is the module and pack assembly process 60.

Accordingly, because the classification control apparatus 100 of the present disclosure predicts thicknesses of battery cells on the basis of stack thicknesses, classifies the battery cells, and combines a plurality of battery cells to form battery modules or battery packs, thicknesses of the battery modules or battery packs may be uniform to within a set or predetermined range (i.e., the thicknesses of the battery modules or battery packs may all fall within a set or predetermined range), and thus compression forces of the battery modules or battery packs may be adjusted.

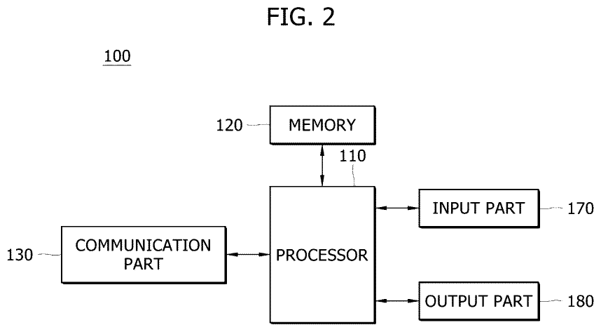

FIG. 2 is a block diagram illustrating a control configuration of the classification control apparatus according to some embodiments of the present disclosure.

Referring to FIG. 2, the classification control apparatus 100 of the present disclosure may include a memory 120, a communication part (i.e., a communication circuit) 130, an input part (i.e., an input circuit) 170, an output part (i.e., an output circuit) 180, and a processor 110.

The memory 120 may store thickness data input from the measurement device 70, prediction data calculated on the basis of the thickness data, and group data pertaining to final thicknesses of battery cells (e.g., predicted final cell package thicknesses) and battery cell groups set on the basis of and thicknesses of the battery cells. In addition, the memory 120 may store simulation data for the battery cells, simulation result data, and defective cell data.

The memory 120 may store data pertaining to at least one of a thickness prediction algorithm, a simulation algorithm, a group setting algorithm, a compression force control algorithm, and a cell classification algorithm.

For example, the memory 120 may include a storage medium including a random-access memory (RAM), a non-volatile memory such as a read only memory (ROM) and an electrically erasable programmable ROM (EEPROM), a flash memory, a hard disk drive (HDD), a solid-state drive (SSD), and a software-defined storage (SDS), etc.

In some cases, the classification control apparatus 100 may include a database (DB) to store a large amount of data such as simulation data and result data in the DB.

The communication part 130 transmits and receives data of each part. The communication part 130 may be connected to the battery manufacturing apparatus 1 and the measurement device 70 and may receive data pertaining to (e.g., identifying) a manufacturing state of battery cells and receive thickness data pertaining to the battery cells (e.g., thicknesses of the battery cells). In addition, the communication part 130 may input a control signal to the classification buffers to correspond to a control command of the processor 110 and transmit data about battery cell groups to the module and pack assembly process 60.

For example, the communication part 130 may perform communication through a wireless communication method such as wireless fidelity (Wi-Fi), Bluetooth, ZigBee, and mobile communication (e.g., long term evolution and 5th generation mobile communication), and perform communication using a wired communication method such as serial communication, Ethernet, and Power-line communication.

The input part 170 may include at least one input means of a button, a switch, and a touch pad, and may receive a user's data. The input part 170 may receive the user's command for predicting thicknesses of battery cells and detecting defect data.

The output part 180 may include at least one of a speaker, an operation lamp, and a display. The output part 180 may output data of the battery manufacturing apparatus 1 received through the communication part 130. In addition, the output part 180 may output measured data and predicted data of battery cells and output data corresponding to battery cell groups set on the basis thicknesses of the battery cells.

The output part 180 may output a warning message through the display or output a warning sound through the speak when an abnormality occurs or a defective battery cell is detected. In addition, the output part 180 may output at least one of a sound effect, a warning sound, and a voice guidance during a process.

The processor 110 may include at least one microprocessor and operate on the basis of data and an algorithm stored in the memory 120.

The processor 110 may manage data received through the communication part 130, data input through the input part 170, data output through the output part 180, and data in the memory 120.

When the processor 110 receives thickness data from the measurement device 70, the processor 110 may store the thickness data in the memory 120 and predict thicknesses of battery cells. The processor 110 may calculate predicted thicknesses using different equations according to types, models, and characteristics of battery cells. The processor 110 may correct the thickness prediction equations by comparing predicted thicknesses and measured thicknesses.

The processor 110 predicts thicknesses of final cell packages on the basis of thickness data measured during the stack process 10, that is, stack thicknesses. The processor 110 may predict thicknesses of cell packages from the stack thicknesses and predict the thicknesses of the final cell packages on the basis of the predicted cell package thicknesses in order to improve accuracy during calculating of the predicted final cell package thicknesses without calculating the predicted final cell package thicknesses from the stack thicknesses.

The processor 110 may set (e.g., determine) grades of battery cells on the basis of the predicted final cell package thicknesses.

When the thicknesses measured during the cell package process 30 or the final cell package process 40 are used, because the process time may be long due to the time it takes to actually classify battery cells, the processor 110 predicts thicknesses of final cell packages on the basis of measured thicknesses measured during the stack process 10, sets (e.g., determines or identifies) grades of the battery cells, and immediately classifies the battery cells when the final cell package process 40 is completed.

The processor 110 may simulate the possibility of defect occurrence when battery modules or battery packs are produced on the basis of stack thicknesses. The processor 110 diagnoses the defect possibility on the basis of a designated simulation and classifies a battery cell that is predicted to be defective in advance on the basis of a result of the simulation. The processor 110 may input a signal to the battery manufacturing apparatus 1 to exclude the battery cell, which is predicted to be defective, during a process.

The processor 110 may set battery cell groups by combining battery cells such that thicknesses are uniform when battery modules or battery packs are assembled on the basis of predicted thicknesses of final cell packages, that is, the predicted final cell package thicknesses, or grades of the battery cells. The processor 110 may set (e.g., determine) the battery cell groups by combining particular ones of the battery cells according to the grades through a simulation with the aim of producing battery modules or battery packs that are uniform in thickness to within a set or predetermined range (i.e., have thicknesses that fall within a set or predetermined range).

In such examples, the processor 110 may set a reference thickness according to a manufacturing model and combine a plurality of battery cells through a simulation such that the thickness of a battery module or battery pack is determined to be within a set or predetermined error range based on the reference thickness.

The processor 110 may set a battery cell group in which a plurality of battery cells having different thicknesses are combined, and provide (e.g., input) group data about the battery cell group to the battery manufacturing apparatus 1.

Accordingly, the processor 110 may set and classify grades of battery cells according to the thicknesses of the battery cells and control battery modules or battery groups to be quickly assembled during a battery manufacturing process.

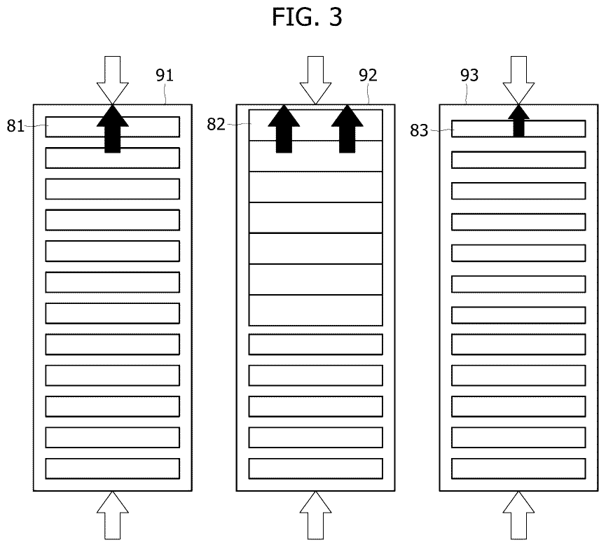

FIG. 3 is a reference view for describing a compression force of a battery module according to some embodiments of the present disclosure.

Referring to FIG. 3, final thicknesses of battery cells 81, 82, and 83 may be different according to the thicknesses of electrode plates.

A first battery cell 81 has a first thickness, a second battery cell 82 has a second thickness greater than the first thickness, and a third battery cell 83 has a third thickness smaller than the first thickness (i.e., the third thickness<the first thickness<the second thickness).

In such examples, when simple loading is performed according to an order of manufacture, a first battery module 91 may be assembled with the battery cells having the first thickness, the second battery module 92 may be assembled with the battery cells having the second thickness, and the third battery module 93 may be assembled with the battery cells having the third thickness. In such examples, a compression force of the second battery module 92 may increase to cause a defect, and a compression force of the third battery module 93 may decrease to cause a problem of contraction of the package.

Accordingly, the classification control apparatus 100 of the present disclosure may predict thicknesses of battery cells, set and classify grades of the battery cells according to the thicknesses of the battery cells such that battery cells having a specific thickness are not input to a specific battery module, and control battery cells having a plurality of thicknesses to be combined according to the grades to assemble battery modules or battery packs.

In the classification control apparatus 100, because the thicknesses of battery modules or battery packs are uniform within an error range even when the thicknesses of battery cells are different from each other, compression forces of the battery modules or battery packs can be controlled, and a defect rate of final products can be reduced.

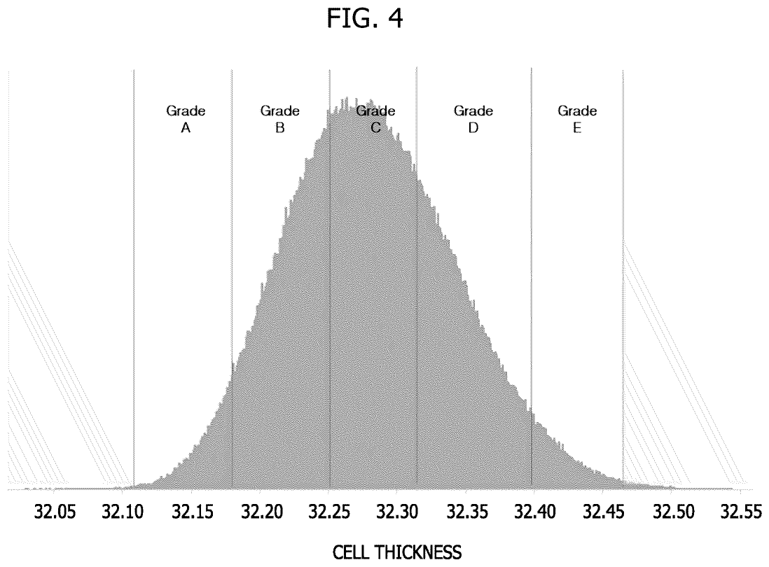

FIG. 4 is a view illustrating grades of thicknesses of battery cells according to some embodiments of the present disclosure.

Referring to FIG. 4, the classification control apparatus 100 may classify thicknesses of battery cells into 5 grades. In such examples, the number of grades and reference values for classifying the grades may be changed according to setting.

The classification control apparatus 100 may set the grades by checking a distribution of the battery cells manufactured according to models of the battery cells.

The classification control apparatus 100 sets the grades of the battery cells using predicted final cell package thicknesses calculated on the basis of stack thicknesses among the thicknesses of the battery cells. The classification control apparatus 100 may set the grade among grades A to E.

The classification control apparatus 100 may set the grades of the battery cells on the basis of the thicknesses at the grades. The grade A refers to a smallest thickness, and the grade E refers to a greatest thickness.

The classification control apparatus 100 may perform a simulation to group battery cells according to grades set on the basis of predicted thicknesses by considering the number of battery cells accommodated in battery modules and battery packs. The classification control apparatus 100 may set battery cell groups by combining a plurality of battery cells such that thicknesses of battery modules are within a set or predetermined range. For example, the classification control apparatus 100 may set battery cell groups by combining the grade C, the grade A, and the grade E or combining the grade C, the grade B, and the grade D.

The classification control apparatus 100 may perform a simulation on the basis of an arrangement of battery cells and units of battery cells disposed during a process and may perform a simulation in units of works or units of specific operation times.

In addition, when a predicted thickness of a final cell package is outside a set range, the classification control apparatus 100 may determine a corresponding cell as a defective cell. For example, the classification control apparatus 100 may determine a battery cell, of which a predicted thickness of a final cell package is greater than that at the grade E, or a battery cell of which a predicted thickness of a final cell package is smaller than that at the grade A, as a defective cell.

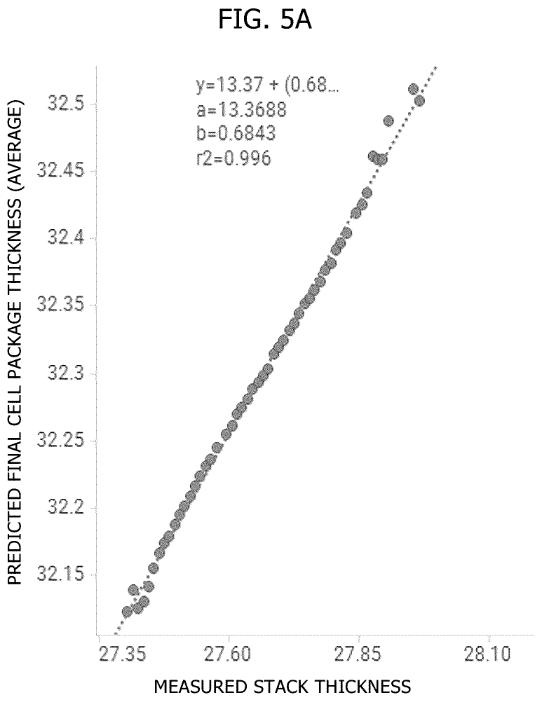

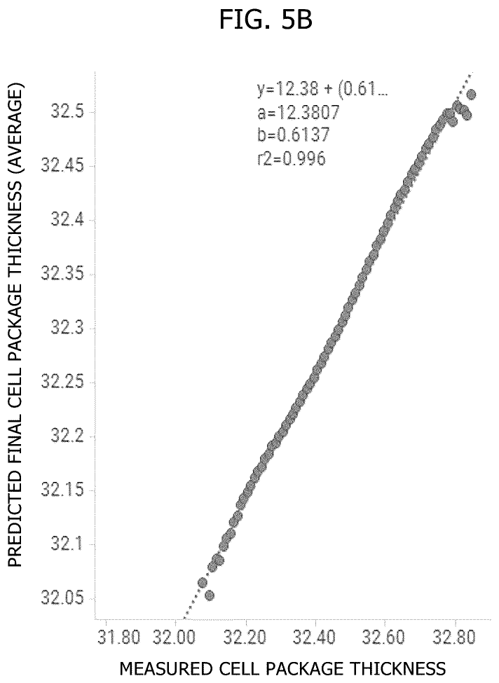

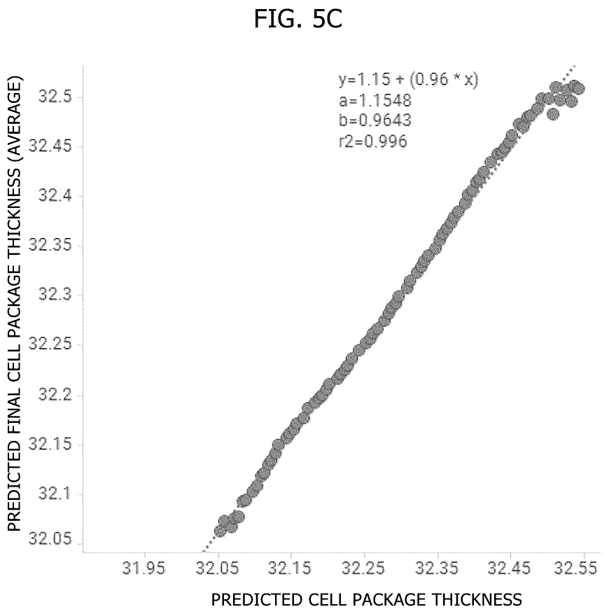

FIGS. 5A, 5B, and 5C are graphs showing predicted thicknesses of battery cells according to some embodiments of the present disclosure.

The processor 110 may receive stack thicknesses (e.g., measured thicknesses) from the measurement device 70 during the stack process 10 and receive thicknesses (e.g., measured thicknesses) of cell packages and thicknesses (e.g., measured thicknesses) of final cell packages during the cell package process 30 and the final cell package process 40.

When the thicknesses (e.g., measured thicknesses) of the cell packages or the thicknesses (e.g., measured thicknesses) of the final cell packages are used to set and classify grades according to thicknesses of battery cells, the thicknesses (e.g., measured thicknesses) of the cell packages or the thicknesses (e.g., measured thicknesses) of the final cell packages may be most accurate references, but in such examples, there is problem of long process times.

Accordingly, the processor 110 predicts thicknesses of final cell packages, in which battery cells are completely packaged, on the basis of stack thicknesses and sets grades of battery cells according to the predicted thicknesses. When the final cell package process 40 is completed, the processor 110 controls the battery cells to be classified according to the grades.

In such examples, the processor 110 is utilized to accurately predict the thicknesses of the final cell packages on the basis of the stack thicknesses. The processor 110 may calculate predicted values on the basis of thicknesses of battery cells for each process in order to predict the accurate thicknesses of the final cell packages on the basis of the stack thicknesses.

Referring to FIG. 5A, the processor 110 may predict thicknesses of final cell packages from measured stack thicknesses. Referring to FIG. 5B, the processor 110 may predict thicknesses of final cell packages on the basis of measured cell package thicknesses. In such examples, the measured thicknesses are thicknesses of battery cells actually measured by the measurement device 70, and the predicted thicknesses are thicknesses predicted using an equation derived on the basis of a correlation between thicknesses of the battery cells during each process.

In addition, as in FIG. 5C, the processor 110 may predict thicknesses of final cell packages on the basis of predicted cell package thicknesses. In such examples, the predicted cell package thicknesses are predicted values predicted on the basis of the measured stack thicknesses.

It may be seen that the predicted final cell package thicknesses calculated on the basis of the measured stack thicknesses are different from the predicted final cell package thicknesses calculated on the basis of the measured cell package thicknesses. The predicted final cell package thicknesses calculated on the basis of the measured cell package thicknesses are calculated similarly to the predicted final cell package thicknesses calculated on the basis of the predicted cell package thicknesses.

Accordingly, the processor 110 may calculate predicted cell package thicknesses on the basis of stack thicknesses and calculate predicted final cell package thicknesses on the basis of the predicted cell package thicknesses instead of predicting thicknesses of final cell packages from the stack thicknesses.

When stack thicknesses are measured during the stack process 10, the processor 110 calculates predicted final cell package thicknesses on the basis of the stack thicknesses and sets grades of battery cells according to predicted thicknesses of battery cells.

When the final cell package process 40 is completed, the processor 110 may classify the battery cells according to the set grades.

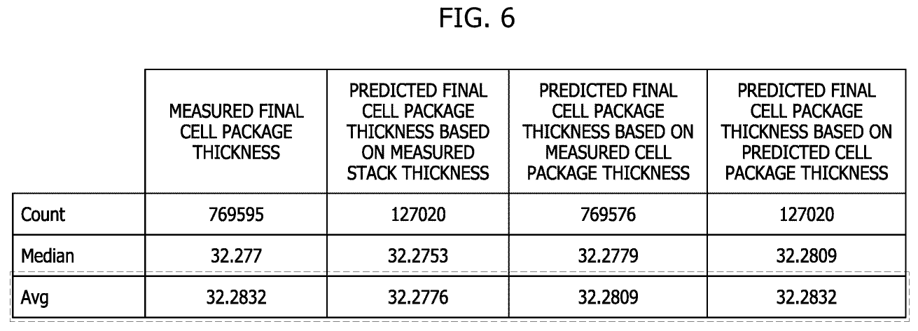

FIG. 6 is an exemplary table showing thicknesses and predicted values of battery cells for each manufacturing step according to some embodiments of the present disclosure.

Referring to FIG. 6, thicknesses of battery cells may be compared according to the number of samples (Count), a median value (Median), and an average value (Avg).

When measured final cell package thicknesses, predicted final cell package thicknesses based on measured stack thicknesses, predicted final cell package thicknesses based on measured cell package thicknesses, and predicted final cell package thicknesses based on predicted cell package thicknesses are compared, it may be seen that an average value of the predicted final cell package thicknesses based on the predicted cell package thicknesses are similar to an average value of the measured final cell package thicknesses.

In such examples, the processor 110 may calculate the predicted cell package thicknesses on the basis of the measured stack thicknesses and calculate the predicted final cell package thicknesses on the basis of the predicted cell package thicknesses by predicting the final cell package thicknesses on the basis of the predicted cell package thicknesses.

Accordingly, when stack thicknesses are measured during the stack process 10, the classification control apparatus 100 of the present disclosure may predict thicknesses of cell packages on the basis of the measured stack thicknesses, predict thicknesses of final cell packages on the basis of the predicted cell package thicknesses, and set grades of battery cells on the predicted thicknesses

The processor 110 may calculate a predicted thickness of a battery cell on the basis of Equation 1. In such examples, Equation 1 is derived by analyzing a correlation between a stack thickness, a thickness of a cell package, and a thickness of a final cell package on the basis of actually measured thickness data.

$$Y 1 = a 0 + a 1 \times X + a 2 \times {X}^{2} + a 3 \times {X}^{3} \qquad Equation 1$$

$$Y 2 = b 0 + b 1 \times Y 1$$

In such examples, X is a measured stack thickness, Y1 is a predicted thickness of a cell package, and Y2 is a predicted thickness of a final cell package. The parameters a0 and b0 are constants, and a1, a2, a3, and b1 are coefficients of X and Y and may be changed according to a model of a battery cell. The constants and coefficients may be calculated from average values of differences in thickness, which have distance of 0.01 mm, of the battery cells, and may be calculated on the basis of data with a correlation coefficient of 0.99 or more. The calculated constants and coefficients may be prestored in the memory 120 for each model and used for thickness prediction.

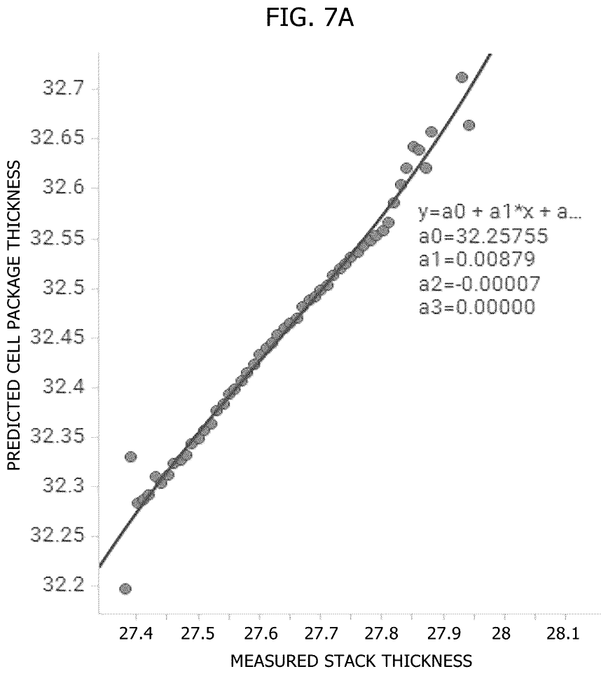

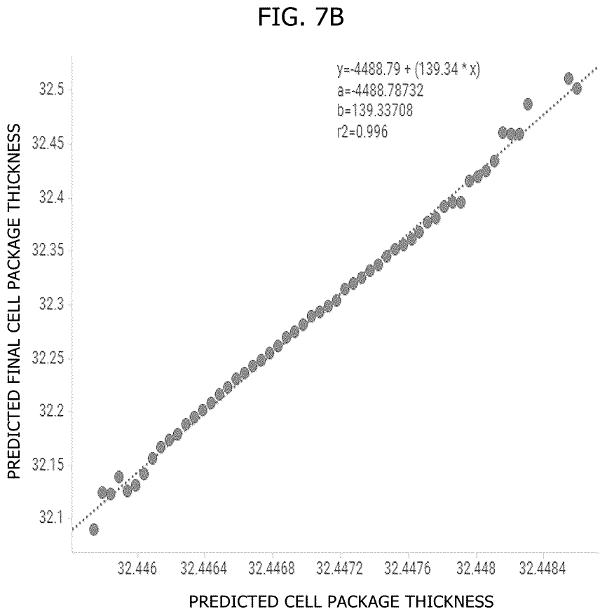

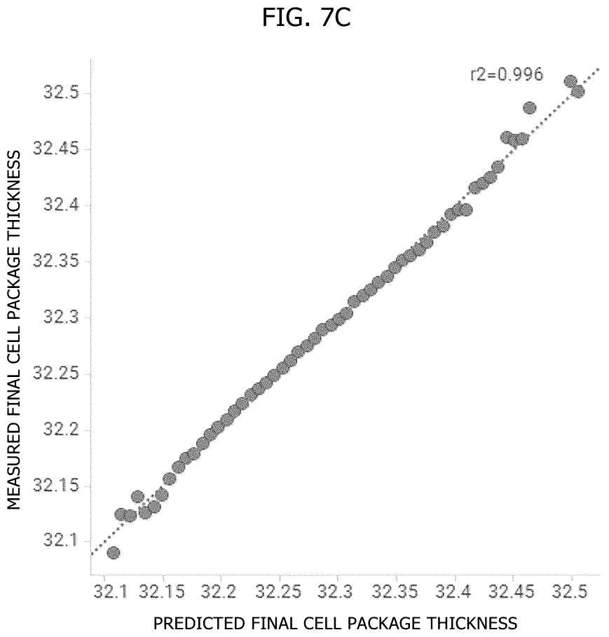

FIGS. 7A, 7B, and 7C are exemplary graphs showing predicted thicknesses of battery cells for each manufacturing step according to some embodiments of the present disclosure.

Referring to FIG. 7A, the processor 110 may calculate a predicted cell package thickness (e.g., an average value) on the basis of a measured stack thickness. Referring to FIG. 7B, the processor 110 may calculate a predicted final cell package thickness (e.g., an average value) on the basis of the predicted cell package thickness.

Referring to FIG. 7C, when a value of the predicted final cell package thickness and a value of a measured final cell package thickness are compared, it may be seen that the two values are similar to each other.

Accordingly, the processor 110 may predict thicknesses of battery cells step by step for each process, set grades of the battery cells on the basis of the predicted thicknesses before the final cell package process 40 is completed, and classify the battery cells according to the grades when the final cell package process 40 is completed.

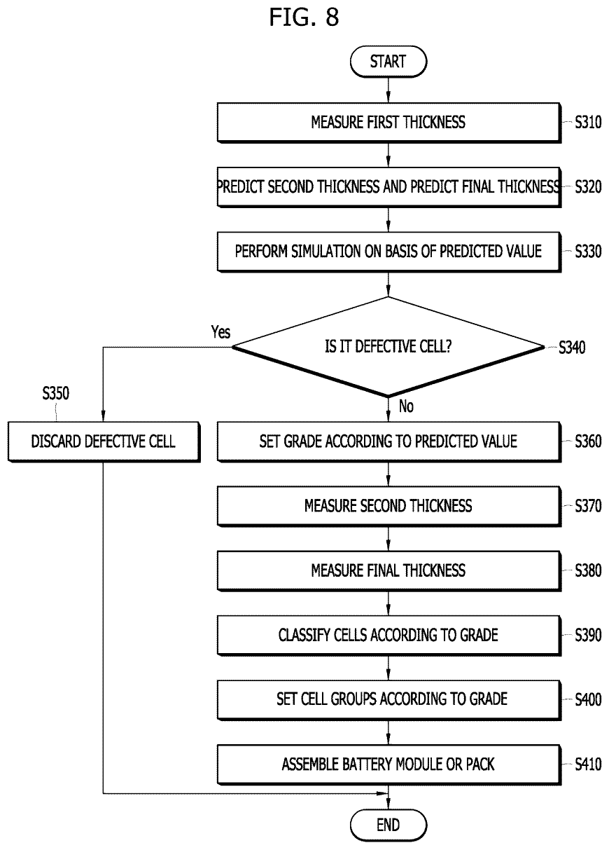

FIG. 8 is a flowchart illustrating a method of controlling battery cell classification according to some embodiments of the present disclosure.

Referring to FIG. 8, the classification control apparatus 100 may be connected to the battery manufacturing apparatus 1 and may receive thickness data, predict thicknesses of battery cells on the basis of the thickness data, and set grades of the battery cells.

The battery manufacturing apparatus 1 measures first stack thicknesses during the stack process 10 (S310). The processor 110 may receive the stack thicknesses from the first measurement device 71.

The processor 110 predicts thicknesses Y1 of cell packages and thicknesses Y2 of final cell packages according to the previously described Equation 1 on the basis of the stack thicknesses (S320). In such examples, the processor 110 may predict the thicknesses of the cell packages on the basis of the stack thicknesses and predict the thicknesses the final cell packages on the basis of the predicted thicknesses of the cell packages (i.e., predicted cell package thicknesses). The processor 110 may change coefficients and constants according to models of battery cells on the basis of Equation and predict thicknesses of battery cells.

The processsor 110 may simulate a case in which actual battery modules or battery packs are assembled on the basis of the predicted final cell package thicknesses (S330). The processor 110 may simulate a combination of battery cells to assemble the battery modules or battery packs on the basis of the number of battery cells included in the battery modules or battery packs and the thicknesses (i.e., predicted thicknesses) of the battery cells. In addition, the processor 110 may simulate compression forces of the battery modules or battery packs.

The processor 110 may determine (e.g., identify) a battery cell, which is predicted to be failed during the simulation, as a defective cell (S340). In examples in which a battery cell may not be combined with a next battery cell or a case in which a predicted thickness of a battery cell is outside a set range, the processor 110 may determine the corresponding battery cell as a defective cell. When the corresponding battery cell is determined as the defective cell, the processor 110 separately classifies the corresponding battery cell and allows (e.g., enables) the corresponding battery cell to be discarded (S350).

The processor 110 sets grades of the battery cells on the basis of the thicknesses (predicted thicknesses) of the battery cells (S360). For example, the processor 110 may set a case, in which a predicted thickness is 32.2, as a grade B and a case, in which a predicted thickness is 32.3, as a grade C as illustrated in FIG. 4. The processor 110 stores the grades of the battery cells according to the thicknesses thereof in the memory 120. In such examples, the processor 110 may also set the grades of the battery cells before the simulation is performed.

The battery manufacturing apparatus 1 measures second thicknesses of the cell packages during the cell package process 30 (S370) after the stack process 10 and the assembly process 20 are performed. In addition, the battery manufacturing apparatus 1 inspects the cell packages, completes the cell packages, and measures thicknesses of the final cell packages (S380).

The processor 110 receives thickness data from the second measurement device 72 and the third measurement device 73. The processor 110 may compare the predicted thicknesses and the measured thicknesses to correct the constants and coefficients of Equation 1.

The processor 110 may transmit grade data set to the battery cells to the battery manufacturing apparatus 1 and control the corresponding battery cells to be classified according to the grades. Accordingly, the battery manufacturing apparatus 1 classifies the battery cells according to the grades and loads the corresponding battery cells on the buffers during the classification process 50 (S390) after the final cell package process 40 is performed.

In such examples, the processor 110 sets battery cell groups on the basis of a simulation result (S400). Group data about the battery cell groups is used during the module and pack assembly process 60.

The battery manufacturing apparatus 1 outputs and moves the classified battery cells according to the grades and assembles the battery modules or battery packs (S410). The battery manufacturing apparatus 1 may combine a plurality of battery cells to assemble the battery modules or battery packs on the basis of the group data received from the classification control apparatus 100.

According to some embodiments of the present disclosure, the thicknesses of final cell packages are predicted, battery cells are classified according to the thicknesses, an assembly process is performed, and thus the thicknesses of battery modules or battery packs can be uniform.

According to some embodiments of the present disclosure, a compression force of a battery module or battery pack including battery cells can be controlled, and a defective cell can be classified in advance to reduce a defect rate of the battery cells and improve the quality of the product.

According to some embodiments of the present disclosure, the thicknesses of battery modules or battery packs can be uniform by predicting thicknesses of final cell packages, classifying battery cells according to the predicted thicknesses, and combining the classified battery cells to assemble the battery modules.

According to some embodiments of the present disclosure, a compression force of a battery module or battery pack including a plurality of battery cells can be effectively adjusted.

According to some embodiments of the present disclosure, a defective cell can be removed in advance by performing a simulation on the basis of a predicted thickness of a battery cell, and a defect rate of the battery cell can be reduced.

According to some embodiments of the present disclosure, the quality of a battery module and a battery pack can be improved by removing a defect of a battery cell and adjusting a compression force of the battery module.

However, effects that can be achieved through the present disclosure are not limited to the above-described effects and other effects that are not described may be clearly understood by those skilled in the art from the detailed descriptions.

The term “unit” as used herein may include a unit implemented in hardware, software, or firmware, and may be used interchangeably with terms such as logic, logic block, component, or circuit. A “unit” may be an integral component or the smallest unit or part thereof performing one or more functions. For example, according to some embodiments, a “unit” may be implemented in the form of an ASIC (Application-Specific Integrated Circuit).

The embodiments described herein may be implemented, for example, as a method or process, a device, a software program, a data stream, or a signal. Although discussed in the context of a single type of implementation (e.g., discussed only as a method), features discussed herein may also be implemented in other forms (e.g., a device or a program). The device may be implemented by suitable hardware, software, firmware, and the like. The method may be implemented on a device, such as a processor that generally refers to a processing device including a computer, a microprocessor, an integrated circuit, a programmable logic device, etc. The processor includes a communication device such as a computer, a cell phone, a personal digital assistant (PDA), and other devices that facilitate communication of information between the device and end-users.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A battery cell classification control apparatus comprising:
a communication circuit configured to receive thickness data from a measurement device that is configured to measure a thickness of a battery cell; and
a processor configured to calculate a predicted thickness by predicting a final thickness of the battery cell to be packaged based on the thickness data, to set a grade of each battery cell based on the predicted thickness, and when the battery cell is packaged, to control the battery cell to be classified according to the grade.

2. The battery cell classification control apparatus of claim 1, wherein the processor is configured to calculate the predicted thickness based on the thickness data measured during a stack process in which a separator, a negative electrode sheet, and a positive electrode sheet are stacked.

3. The battery cell classification control apparatus of claim 2, wherein the processor is configured to calculate the predicted thickness by predicting a thickness of a cell package that is primarily packaged based on the thickness data, and to predict a thickness of a final cell package that is finally packaged based on a predicted value.

4. The battery cell classification control apparatus of claim 2, wherein the processor is configured to calculate a correlation equation by analyzing the thickness of the battery cell during a stack process, a thickness of a cell package that is primarily packaged, and a thickness of a final cell package that is finally packaged, and to calculate the predicted thickness according to the correlation equation.

5. The battery cell classification control apparatus of claim 1, wherein the processor is configured to perform a simulation for assembling a battery module or a battery pack by combining a plurality of battery cells having different thicknesses, and to set the plurality of battery cells as battery cell groups according to a result of the simulation.

6. The battery cell classification control apparatus of claim 5, wherein the processor is configured to perform the simulation for a uniform thickness of the battery module or the battery pack by combining the plurality of battery cells having different thicknesses.

7. The battery cell classification control apparatus of claim 5, wherein the processor is configured to enable the battery cell to be assembled according to group data associated with the battery cell groups during an assembly process of the battery module or the battery pack.

8. The battery cell classification control apparatus of claim 5, wherein the processor is configured to set a battery cell predicted to be defective as a defective cell during performing of the simulation, and to control the defective cell to be separated before packaging is performed.

9. The battery cell classification control apparatus of claim 1, wherein the processor is configured to determine a battery cell having a predicted thickness outside a set range as a defective cell, and to control the defective cell to be separated before packaging is performed.

10. A battery cell classification control system comprising:
a battery manufacturing apparatus is configured to perform a stack process, a cell package process, a final cell package process, a classification process, and a module pack assembly process; and
a classification control apparatus is configured to predict a thickness of a battery cell, on which the final cell package process is completely performed, based on a thickness of the battery cell measured during the stack process, to set a grade of the battery cell according to the predicted thickness, and to control the battery cell to be classified according to the grade during the classification process.

11. The battery cell classification control system of claim 10, wherein the classification control apparatus is configured to calculate the predicted thickness by predicting the thickness of the battery cell, on which the cell package process is completely performed, based on the thickness of the battery cell measured during the stack process and predicting the thickness of the battery cell, on which the final cell package process is completely performed, based on a predicted value.

12. The battery cell classification control system of claim 10, wherein, the classification control apparatus is configured to separate the battery cell as a defective cell based on the thickness the battery cell being outside a set range.

13. The battery cell classification control system of claim 10, wherein the classification control apparatus is configured to set battery cell groups by combining a plurality of battery cells having different thicknesses based on the predicted thickness and to control the battery cell to be assembled according to group data associated with the battery cell groups during an assembly process of a battery module or a battery pack.

14. A method of controlling battery cell classification, comprising:
receiving, by a processor, thickness data from a measurement device configured to measure a thickness of a battery cell through a communication circuit;
calculating, by the processor, a predicted thickness by predicting a final thickness of the battery cell, which is packaged, based on the thickness data;
setting, by the processor, a grade of the battery cell based on the predicted thickness; and
controlling, by the processor, the battery cell to be classified according to the grade when the battery cell is finally packaged.

15. The method of claim 14, wherein the calculating of the predicted thickness comprises:
predicting, by the processor, a thickness of a cell package, which is primarily packaged, based on of the thickness data; and
calculating, by the processor, the predicted thickness by predicting a thickness of a final cell package, which is finally packaged, based on a predicted value.

16. The method of claim 14, further comprising, after the calculating of the predicted thickness, performing, by the processor, a simulation for assembling a battery module or a battery pack by combining a plurality of battery cells having different thicknesses based on the predicted thickness.

17. The method of claim 16, wherein, in the performing of the simulation, the processor performs the simulation for uniformizing a thickness of the battery module or the battery pack by combining the plurality of battery cells having different thicknesses.

18. The method of claim 16, further comprising, after the performing of the simulation:
setting, by the processor, a battery cell predicted to be defective during performing of the simulation as a defective cell;
setting, by the processor, a battery cell having a predicted thickness outside a set range as a defective cell; and
controlling, by the processor, the defective cell to be separated before packaging is performed.

19. The method of claim 14, wherein, in the receiving of the thickness data, the processor is configured to calculate the predicted thickness of the battery cell, which is finally packaged, based on the thickness data measured during a stack process in which a separator, a negative electrode sheet, and a positive electrode sheet are stacked.
